(19) United States
(12) Patent Application Publication
(10) Pub. No.: US 2023/0173716 A1
(43) Pub. Date: Jun. 8, 2023

(54) Macromolecule Forming Mold, Thermosetting Elastomer and Manufacturing Method Therefor

(71) Applicants: Chia Chuang Hu, New Taipei City (TW); Ming Lung Liu, Taichung City (TW)

(72) Inventors: Chia Chuang Hu, New Taipei City (TW); Ming Lung Liu, Taichung City (TW)

(21) Appl. No.: 17/926,207

(22) PCT Filed: Jun. 10, 2020
(86) PCT No.: PCT/CN2020/095449

§ 371 Date: Nov. 18, 2022

(51) Int. Cl. B29C 33/40; B29C 33/44; B29C 64/40; B29C 39/02; B29C 39/36

(52) U.S. Cl. CPC B29C 33/405; B29C 33/448; B29C 64/40; B29C 39/026; B29C 39/36; B29C 2791/002; B29K 2901/12; B29K 2101/10

(57) ABSTRACT

A macromolecule forming mold, which is integrally formed by a polymer body. Multiple communicated runners are formed inside the polymer body; a material injection port is penetrated in the surface of the polymer body, and the material injection port is communicated with the runners, so that a thermosetting castable fills the runners by means of the material injection port and is cured and molded, and the polymer body is damaged to take out a thermosetting elastomer. A thermosetting elastomer and a manufacturing method therefor. The thermosetting elastomer has the characteristics such as excellent physical properties and lightweight properties.

### FIELD OF INVENTION

The present invention relates to a polymer molding technology, especially to a polymer forming mold, thermosetting elastomer and manufacturing method therefor.

### BACKGROUND OF THE INVENTION

Most of conventional method of polymer molding is filling the polymer raw material into a mold, wherein the polymer raw material can be cured in a space of the mold, and then a polymer product with a specific shape is taken out when the mold is opened.

However, due to the demolding process in the conventional method mentioned above, the mold shape is limited to form the polymer product with a complex structure, so that the structural characteristics of the polymer product cannot be presented.

With the development of technology, 3D printing technology which can directly form various complex shapes without the mold to overcome the conventional molding technology. However, the mainly material required for 3D printing is limited in thermoplastic material, such as thermoplastic polyurethane (TPU) and thermoplastic elastomers (TPE) but not thermosetting castable. As a result, the polymer products made by 3D printing cannot exhibit various material properties and cannot be effectively used in various industrial fields.

### SUMMARY OF THE INVENTION

To overcome the aforementioned shortcomings of the material required for 3D printing is limited and a polymer product made by 3D printing cannot exhibit various material properties, the present invention provides a polymer forming mold; a manufacturing method of a thermosetting elastomer by using the polymer forming mold, and the thermosetting elastomer.

The present invention provides a polymer forming mold made from a one-piece polymer body, wherein the polymer body comprises: multiple runners formed in the polymer body, each runner communicating with each other, and the multiple runners defining a three-dimensional network structure; an injection port defined in a surface of the polymer body, and communicating with at least one of the runners; thereby a thermosetting castable is filled into the runners through the injection port, and a thermosetting elastomer is formed after curing the thermosetting castable and destructing the polymer body.

Wherein, each runner extends through the polymer body with a wave-like shape.

Wherein, each runner comprises: a first segment formed in the polymer body and extending along the direction of an X axis of the polymer body; a second segment formed in the polymer body and extending along the direction of a Y axis of the polymer body and communicating with the first segment of at least one of the runners vertically; a third segment formed in the polymer body and extending along the direction of a Z axis of the polymer body and vertically communicating with first segment of at least one of the runners and the second segment of at least one of the runners, wherein the first segments, the second segments, and the third segments of the runners are formed as the three-dimensional network structure.

Wherein, the polymer body has multiple injection ports respectively communicating with the third segments of the runners, and a shape and the arrangement of the multiple injection ports are corresponding to a shape and an arrangement of the first segments of the runners.

Wherein, each runner comprises a collecting segment and a connecting segment, a cross-section of the collecting segment is basically round, and a diameter of the collecting segment is bigger than a diameter of the injection ports, the connecting segment is applied to communicate the collecting segment and the injection ports.

The present invention also provides a manufacturing method of the thermosetting elastomer comprising steps of: using a 3D printing to integrally produce the polymer body with the multiple runners communicating with each other therein, defining as a three-dimensional network structure, and an injection port communicating with the runners and defined in the surface of the polymer body; pouring the thermosetting castable into the runners through the injection port; curing the thermosetting castable which is filled into the runners to form a thermosetting elastomer; and destroying the polymer body to take off the thermosetting elastomer.

Wherein pre-heats the thermosetting castable in an environment of 25° C. to 150° C. that the thermosetting castable can be a liquid state for pouring.

Wherein a method of destroying the polymer body can be selected from the group consisting of physical pressuring, heat melting, solvent dissolving, and laser burning.

Wherein a material of the polymer body is a thermoplastic material or a photocurable material, the thermoplastic material is selected from the group consisting of polylactic acid (PLA), acrylonitrile butadiene styrene (ABS), acrylonitrile-styrene-acrylate copolymer (ASA), nylon, polyethylene terephthalate (PET), thermoplastic elastomer (TPE), thermoplastic polyurethane (TPU), polycarbonate (PC), polypropylene (PP) and polyvinyl alcohol (PVA); and the photocurable material is photocurable epoxy resin or acrylic resin.

The present invention further provides a thermosetting elastomer which is made from the manufacturing method mentioned above comprising multiple through holes communicating to each other, and the thermosetting elastomer can be selected from the group consisting of thermosetting polyurethane elastomer, unsaturated polyester resin, epoxy, and silicone.

When the thermosetting castable is filled into the runners, the thermosetting castable may be cured and formed into the thermosetting elastomer with a complex structure corresponding to the three-dimensional network structure of the runners. Since the three-dimensional network structure of the runners, the thermosetting elastomer cannot be taken out from the injection ports directly. But it is feasible to use the difference of the physical property between the thermosetting elastomer and the polymer body to destroy or decomposed the polymer body then to obtain the thermosetting elastomer.

As the manufacturing method of the present invention provided, an effective technique for forming the thermosetting elastomer can be developed into a honeycomb structure and can be applied to a shoe material to provide properties such as enhanced structure or light-weight. And the material of the thermosetting elastomer can be selected from the group consisting of thermosetting polyurethane elastomer, unsaturated polyester resin, epoxy, and silicone that the thermosetting elastomer may exhibit excellent weather resistance, solvent resistance and wear resistance and can be applied in various industrial fields.

### BRIEF DESCRIPTION OF THE DRAWINGS

FIG. 1 is a first preferred embodiment of the polymer forming mold in accordance with the present invention;

FIG. 2 is a cross sectional view along the line 2-2 of FIG. 1;

FIG. 3 is a cross sectional view along the line 3-3 of FIG. 1;

FIG. 4 is a cross sectional view along the line 4-4 of FIG. 1;

FIG. 5 is a block diagram of a preferred embodiment in accordance with the present invention;

FIG. 6 is a thermosetting elastomer formed from the first preferred embodiment in accordance with the present invention;

FIG. 7 is a cross sectional view of a second preferred embodiment of the polymer forming mold in accordance with the present invention;

FIG. 8 is a thermosetting elastomer formed from the second preferred embodiment in accordance with the present invention.

### DESCRIPTION OF THE LABELS IN THE DRAWINGS

100 thermosetting elastomer, 100′ thermosetting elastomer, 110 channel, 110′ channel,
10 polymer body, 10′, 11 runner, 11′ runner,
111 first segment, 111′ collecting segment, 112 second segment, 112′ connecting segment,
113 third segment, 12 injection port, 12′ injection port,
S1 preparing a mold, S2 pouring, S3 curing, S4 demolding.

### DETAILED DESCRIPTION OF THE PREFERRED EMBODIMENTS

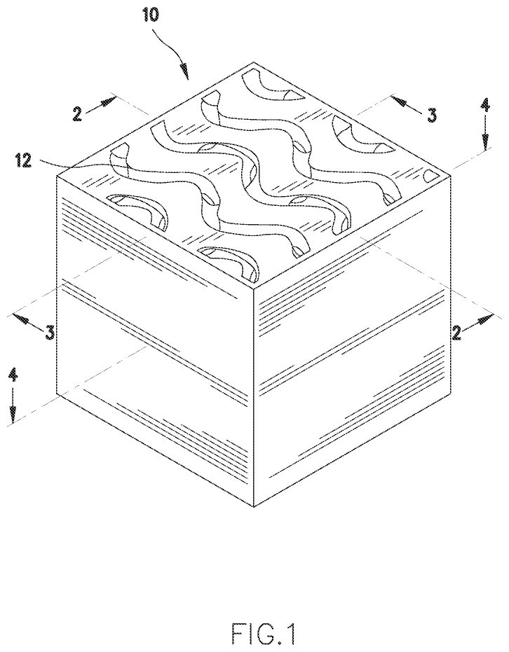

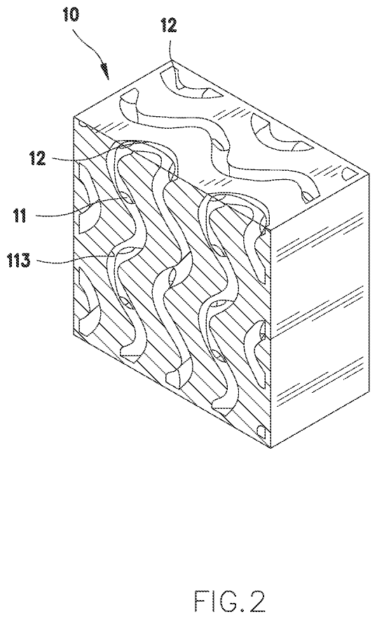

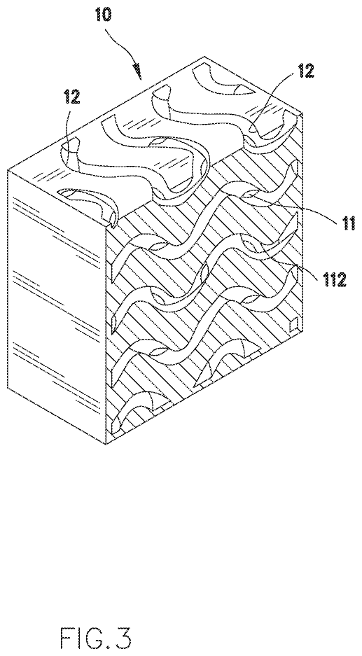

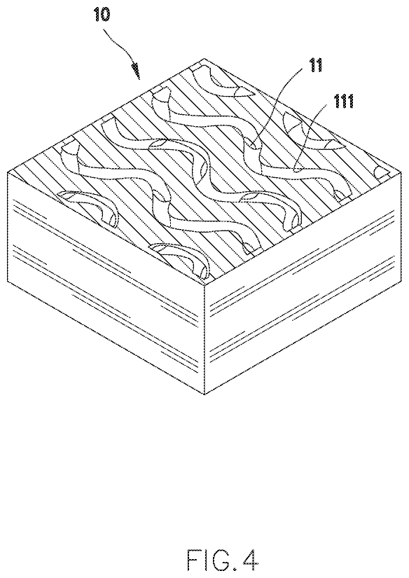

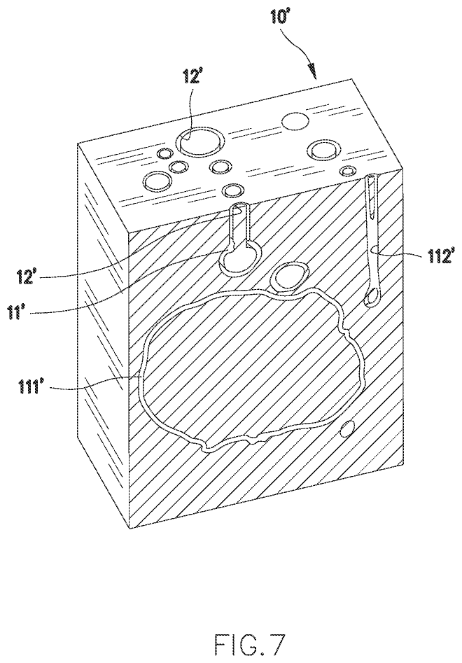

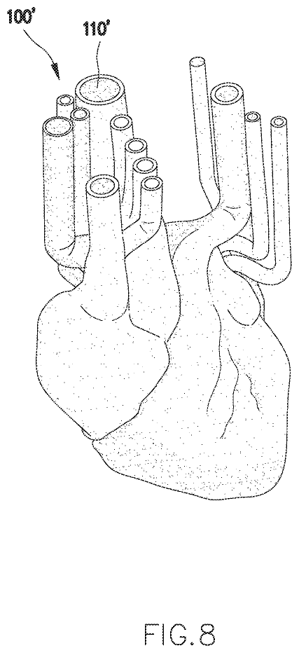

With reference to FIG. 1 to FIG. 8, a polymer forming mold and a manufacturing method of a thermosetting elastomer in accordance with the present invention is provided. Wherein, the first embodiment of the present invention is presented in FIG. 1 to FIG. 6 and the second embodiment of the present invention is presented is FIG. 7 and FIG. 8.

Referring to FIG. 1 to FIG. 4, a first preferred embodiment of the polymer forming mold of the present invention is a polymer body 10 which is one-piece formed. Wherein, multiple runners 11 is formed in the polymer body 10, and each runner 11 communicate with each other. An injection port 12 is defined in a surface of the polymer body 10, and communicate with at least one of the runners 11. A thermosetting castable may be filled into the runners 11 through the injection port 12, and a thermosetting elastomer 100 may be formed after curing the thermosetting castable and destructing the polymer body 10. As the term “thermosetting castable” or “thermosetting elastomer 100” applied herein may refer to any material which can be formed into a shape during manufacture but rigid permanently when receive reheating after heating, due to a unreversible property of cross-linking reaction.

Further description in the first preferred embodiment, multiple runners 11 of the polymer body 10 can define a three-dimensional network structure, and each runner 11 is formed in the polymer body 10 with a wave-like shape. With the FIGS. 1 to FIG. 4, each runner 11 comprises a first segment 111, a second segment 112, and a third segment 113. Each first segment 111 is formed in the polymer body 10 and extending along the direction of a X axis of the polymer body 10. Each second segment 112 is formed in the polymer body 10 and extending along the direction of a Y axis of the polymer body 10, and communicates with the first segment 111 of at least one of the runners 11 vertically. Each third segment 113 is formed in the polymer body 10 and extending along the direction of a Z axis of the polymer body 10, and vertically communicates with the first segment 111 and the second segment 112. Thus, the first segments 111, the second segments 112, and the third segments 113 can be arranged in the three-dimensional network structure. Preferably, the first segments 111 of the runners 11 are spaced apart equidistantly to each other; the second segments 112 of the runners 11 are spaced apart equidistantly to each other; and the third segments 113 of the runners 11 are spaced apart equidistantly to each other, so that the polymer body 10 can present a regularly repeating three-dimensional network structure. Moreover, multiple injection ports 12 communicate with each third segment 113, and the shape and the arrangement of the multiple injection ports 12 are corresponding to the shape and the arrangement of the first segment 111 that make the thermosetting castable be filled into the runners 11.

When the thermosetting castable is filled into the runners 11, the thermosetting castable may be cured and formed into the thermosetting elastomer 100 with a complex structure corresponding to the three-dimensional network structure of the runners 11. With the complex structure of the thermosetting elastomer 100, the thermosetting elastomer 100 can only be taken out by destroying the polymer body 10 by a difference of a physical material property between the thermosetting elastomer 100 and the polymer body 10.

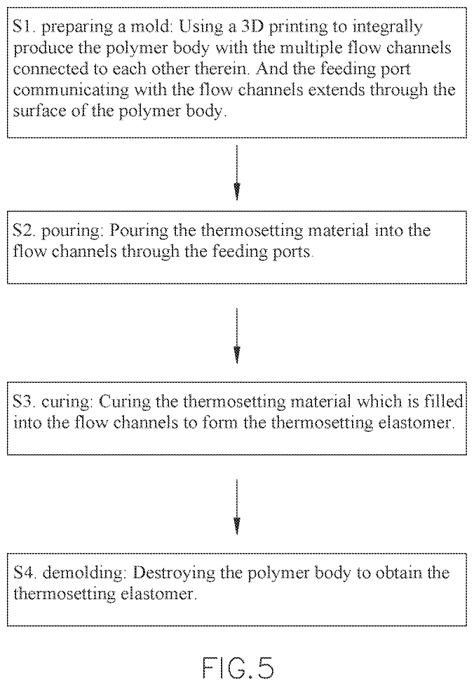

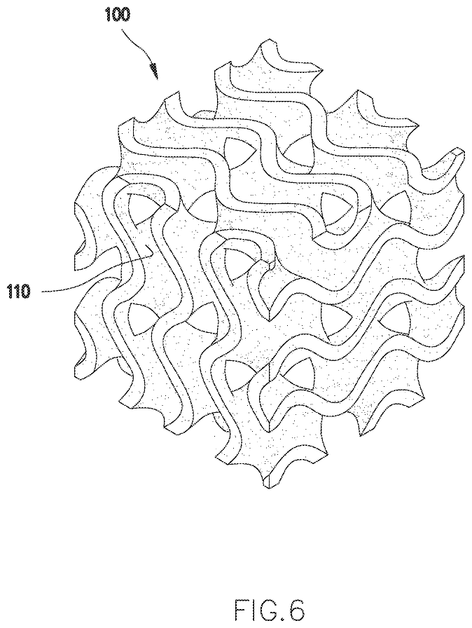

FIG. 5 and FIG. 6 reveals a manufacturing method of the thermosetting elastomer comprising steps of:

S1. preparing a mold: Using a 3D printing to integrally produce the polymer body 10 with the multiple runners 11 communicating with each other therein. Multiple injection ports 12 communicating with the runners 11 are defined in the surface of the polymer body 10. In a preferred embodiment, a material of the polymer body 10 can be a thermoplastic material or a photocurable material. The thermoplastic material can be selected from the group consisting of polylactic acid (PLA), acrylonitrile butadiene styrene (ABS), acrylonitrile-styrene-acrylate copolymer (ASA), nylon, polyethylene terephthalate (PET), thermoplastic elastomer (TPE), thermoplastic polyurethane (TPU), polycarbonate (PC), polypropylene (PP) and polyvinyl alcohol (PVA). The photocurable material can be photocurable epoxy resin or acrylic resin.

S2. pouring: Pouring the thermosetting castable into the runners 11 through the injection ports 12. In the preferred embodiment, the thermosetting castable is a raw material of a thermosetting poly urethane elastomer. The thermosetting castable can be pre-prepared with a ratio of end groups of isocyanate, hydroxyl, and amine as required. Then pre-heating the thermosetting castable in an environment of 25° C. to 150° C. Thus, the thermosetting castable can be a liquid state for pouring.

S3. curing: Curing the thermosetting castable which is filled into the runners 11 to form the thermosetting elastomer 100. It is worthily mentioned that the thermosetting castable may be cross-linked and cured via cooling or heating to form the thermosetting elastomer 100.

S4. demolding: destroying the polymer body 10 to obtain the thermosetting elastomer 100. Since the three-dimensional network structure of the runners 11 made from the first channel 111, the second channel 112, and the third channel 113, the thermosetting elastomer 100 cannot be taken out from the injection ports 12 directly. However, it is feasible to use the difference of the physical property between the thermosetting elastomer 100 and the polymer body 10 to destroy or decompose the polymer body 10 then to obtain the thermosetting elastomer 100. The method of destroying or decomposing the polymer body 10 can be selected from the group consisting of physical pressuring, heat melting, solvent dissolving, and laser burning.

In some embodiments, when the polymer body 10 is the photocurable material which has a material feature with a molecular movement is restricted and without elastic, the polymer body 10 is easier to break comparing to the thermoset elastomer 100. Thus, providing a physical pressure from a pressurized device to the polymer body 10 with the thermosetting elastomer 100 therein, the polymer body 10 be broken due to the difference of a physical property that the thermosetting elastomer would be remain intact and be taken out eventually. In certain embodiment, when the polymer body 10 is the thermoplastic material, because the thermosetting elastomer 100 has an unreversible rigid permanently property, the thermosetting elastomer 100 may be taken out by thermal melting the polymer body 10 directly. Yet in certain embodiment, the polymer body 10 can be made by water-soluble polyvinyl alcohol, that can demold and obtain the thermosetting elastomer 100 by immersing and dissolving the polymer body 10 in water.

Thereby, the manufacturing method of the present invention provides an effective technique for forming the thermosetting elastomer 100 which comprises multiple channels 110 that the thermosetting elastomer 100 can be developed into a honeycomb structure or a regularly repeating three-dimensional structure and can be applied into a shoe material to provide properties such as enhanced structure or light-weight.

Moreover, a material of the thermosetting elastomer 100 can be selected from the group consisting of thermosetting polyurethane elastomer, unsaturated polyester resin, epoxy, and silicone. Consequently, the thermosetting elastomer 100 may exhibit excellent weather resistance, solvent resistance and wear resistance and can be applied in various industrial fields.

According to the FIG. 7 and FIG. 8, a second preferred embodiment of the present invention is provided. The polymer body 10′ comprises the runners 11′ and the injection ports 12′ which are mentioned above. In the preferred embodiment, the runners 11′ comprises a collecting segment 111′ and a connecting segment 112′, A cross-section of the collecting segment 111′ is basically round, and the diameter of the collecting segment 111′ is bigger than the injection ports 12′. The connecting segment 112′ is applied to communicate the collecting segment 111′ and the injection ports 12′, When the thermosetting castable is poured into the polymer body 10′, the thermosetting castable may be cured corresponding to the runners 11′ that a heart-like model of the thermosetting elastomer 100′ can be formed with multiple channels 110′ which is simulated the blood vessels. Thus, the present invention can be further applied into medical field that improves simulation effect of the model through the use of materials and achieves the purpose of medical teaching.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A polymer forming mold made from a one-piece polymer body, wherein the polymer body comprises:
multiple runners formed in the polymer body, each runner communicating with each other, and an injection port defined in a surface of the polymer body, and communicating with at least one of the runners; thereby a thermosetting castable is filled into the runners through the injection port, and a thermosetting elastomer is formed after curing the thermosetting castable and destructing the polymer body.

2. The polymer forming mold as claimed in claim 1, wherein the multiple runners define a three-dimensional network structure; and each runner is formed in the polymer body with a wave-like shape.

3. The polymer forming mold as claimed in claim 2, wherein each runner comprises a first segment formed in the polymer body and extending along the direction of an X axis of the polymer body; a second segment formed in the polymer body and extending along the direction of a Y axis of the polymer body and communicating with the first segment of at least one of the runners vertically; and a third segment formed in the polymer body and extending along the direction of a Z axis of the polymer body and vertically communicating with first segment of at least one of the runners and the second segment of at least one of the runners, wherein the first segments, the second segments, and the third segments of the runners are formed as the three-dimensional network structure.

4. The polymer forming mold as claimed in claim 3, wherein the polymer body has multiple injection ports respectively communicating with the third segments of the runners, and a shape and the arrangement of the multiple injection ports are corresponding to a shape and an arrangement of the first segments of the runners.

5. The polymer forming mold as claimed in claim 1, wherein each runner comprises a collecting segment and a connecting segment, a cross-section of the collecting segment is basically round, and a diameter of the collecting segment is bigger than a diameter of the injection ports, the connecting segment is applied to communicate the collecting segment and the injection ports.

6. A manufacturing method of the thermosetting elastomer comprising steps of:
using a 3D printing to integrally produce the polymer body with the multiple runners communicating with each other therein, and an injection port communicating with the runners and defined in the surface of the polymer body;
pouring the thermosetting castable into the runners through the injection port;
curing the thermosetting castable which is filled into the runners to form a thermosetting elastomer; and
destroying the polymer body to take off the thermosetting elastomer.

7. The manufacturing method of the thermosetting elastomer as claimed in claim 6, wherein pre-heats the thermosetting castable in an environment of 25° C. to 150° C. that the thermosetting castable can be a liquid state for pouring.

8. The manufacturing method of the thermosetting elastomer as claimed in claim 7, wherein a method of destroying the polymer body can be selected from the group consisting of physical pressuring, heat melting, solvent dissolving, and laser burning.

9. The manufacturing method of the thermosetting elastomer as claimed in claim 6, wherein a material of the polymer body is a thermoplastic material or a photocurable material, the thermoplastic material is selected from the group consisting of polylactic acid (PLA), acrylonitrile butadiene styrene (ABS), acrylonitrile-styrene-acrylate copolymer (ASA), nylon, polyethylene terephthalate (PET), thermoplastic elastomer (TPE), thermoplastic polyurethane (TPU), polycarbonate (PC), polypropylene (PP) and polyvinyl alcohol (PVA); and the photocurable material is photocurable epoxy resin or acrylic resin.

10. A thermosetting elastomer which is made from the manufacturing method in claim 6 comprising multiple through holes communicating to each other, and the thermosetting elastomer can be selected from the group consisting of thermosetting polyurethane elastomer, unsaturated polyester resin, epoxy, and silicone.
